(19) United States
(12) Patent Application Publication
(10) Pub. No.: US 2011/0029355 A1
(43) Pub. Date: Feb. 3, 2011

(54) SYSTEM AND METHOD FOR PROVIDING TARGETED ADVERTISEMENTS AND INFORMATION OVER A WIRELESS COMMUNICATIONS NETWORK BASED ON CURRENT GPS LATITUDE AND LONGITUDE POSITIONS

(76) Inventor: Glenn Harris Hann, Mount Laurel, NJ (US)

Correspondence Address: Glenn Harris Hann, 51 Knighton Lane, Mt Laurel, NJ, 08054, US

(21) Appl. No.: 12/472,896

(22) Filed: Jul. 31, 2009

(51) Int. Cl. G06Q 30/00

(52) U.S. Cl. 705/14.1; 705/14.58; 705/14.64

(57) ABSTRACT

A method and system for providing targeted advertisement and informational announcements with selected ringtones to consumers over a wireless communications network. In one embodiment, local advertisers register to iphoneappdata.com, when communication devices are in close proximity, as a consumer enters a predetermined GPS longitude and latitude coordinate that is near the location of the advertiser, the wireless network delivers a message and corresponding ringtone to the wireless device which is specified by the local advertiser. In a further embodiment, each of the messages stored in the database is also associated with one or more sub advertiser codes so unique advertisements can be sent from multiple chain advertisers. A follow-up advertisement can be sent after a pre-established waiting period and database checks are performed to determine if the same advertisement was sent out previously or within a specified period.

### BACKGROUND OF THE INVENTION

As wireless communications technology continues to improve and become a more affordable, the general public is becoming increasingly dependent upon wireless communications devices to communicate with others when conventional line telephones are unavailable. As a result, many users are almost always accessible, even while driving or shopping. As is generally known, wireless communication devices receive GPS longitude and latitude information. Recent technological advances in digital user interfaces have added versatility to wireless communications devices by enabling users to access text and graphic information over the screen of the device. For example, most digital cellular telephones at a minimum display the current time and date and pictures. Although wireless communication devices are used for voice-based telephone or text-based e-mail communications, it has not been known to effectively utilize such devices to receive targeted consumer advertisement information.

### SUMMARY OF THE INVENTION

In view of the difficulties described above, there is a need for a method and system for providing targeted advertisement information to consumers over a wireless communications network. In one embodiment, local advertisers register to advertise on certain wireless communications devices that are in close proximity to the advertiser. As a consumer enters a set longitude and latitude site that is near the location oft he advertiser, the wireless network delivers a message and ring tone to the wireless device that is specified by the local advertiser. It is therefore an object of the present invention to provide a method for transmitting a message over a wireless network to a wireless communication device. A plurality of messages are stored in a database, wherein each stored message is associated with one or more locations. Longitude and latitude information of a wireless communication device is transmitted and matched to an advertisers or informational location, a message in the database is then transmitted back to the wireless communication device. Recording keeping in the database is stored so repeat messaging is suppressed while the wireless communication device is within the same longitude and latitude matching location.

As another object of the present invention is to provide a system for transmitting informational messages and ringtone from a particular landmark, zone, point of interest providing information to the wireless device.

Another object of the present invention is to guide consumers through retail environments identifying points of interest or advertising information as they proceed down the aisles.

### DESCRIPTION OF THE DRAWINGS

FIG. 1 is a breakdown of the application as designed to run on a wireless device in interactive or push mode.

FIG. 2 is a breakdown of the application as designed to run in a web server environment providing the longitude and latitude match, and providing the record keeping of the advertisement or information that has been sent to a particular wireless device using that device unique id, date and time of message that was sent.

FIG. 3 represents a screen representation of the wireless device along with the user interactive key to clear the current advertisement of informational request from the screen.

FIG. 3A represents a clean version of the screen.

FIG. 4 represents a block diagram of the data elements received into the wireless device and transmitted and received from the web platform.

FIG. 5 represents a breakdown of the database and associated retained elements.

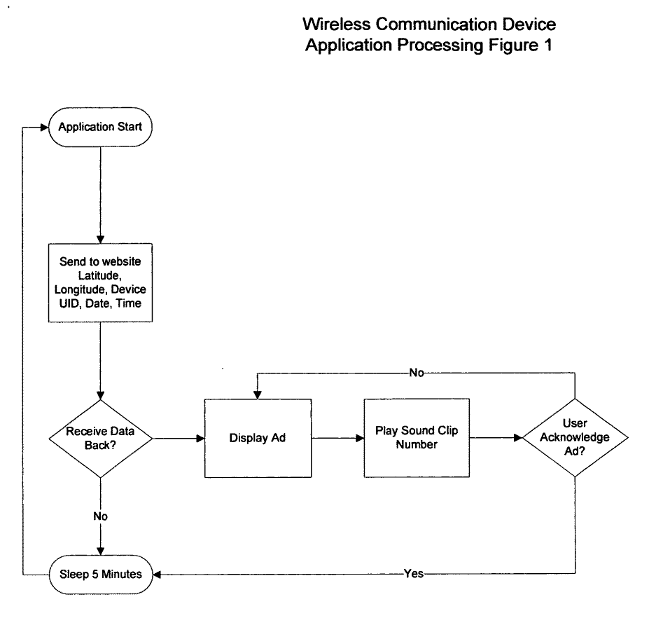

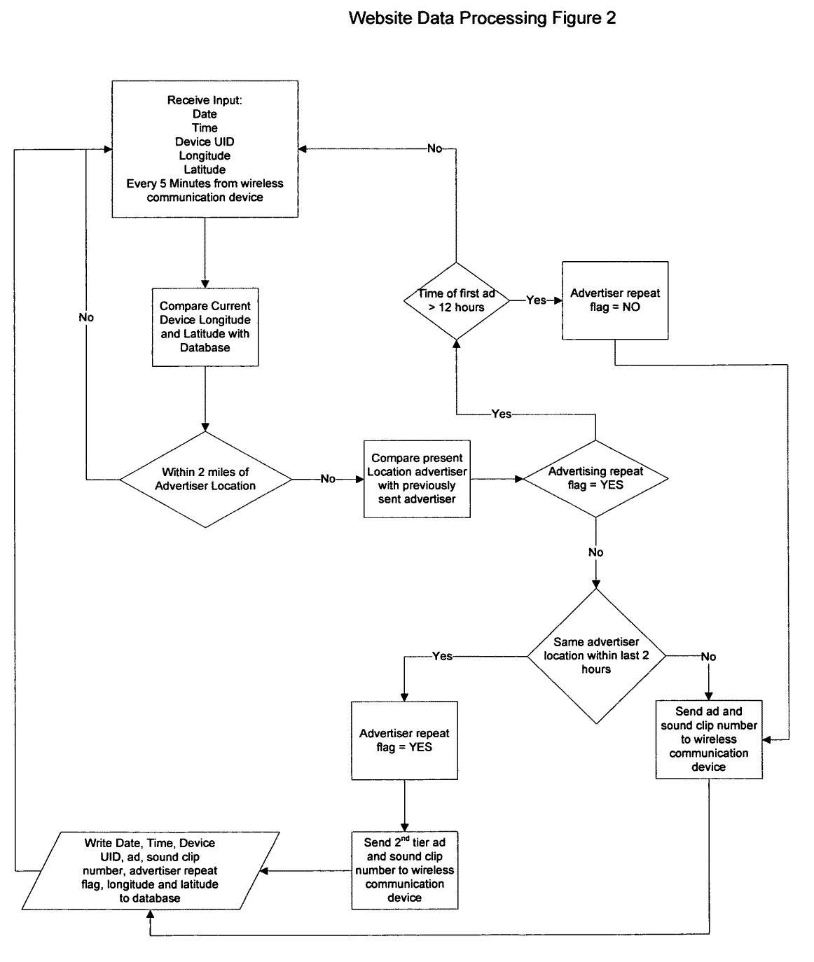

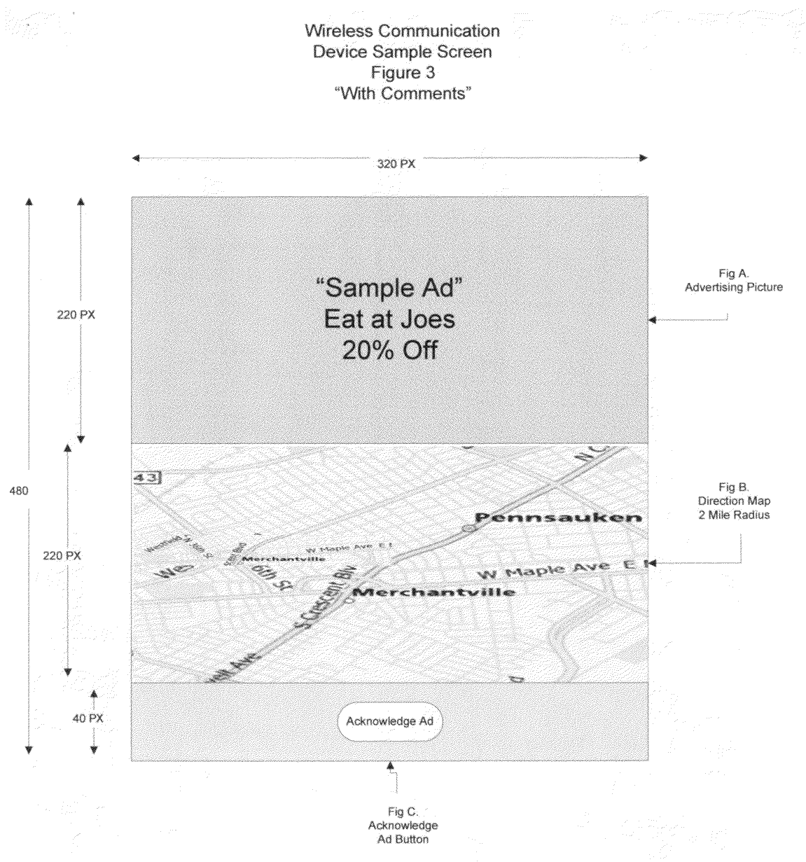

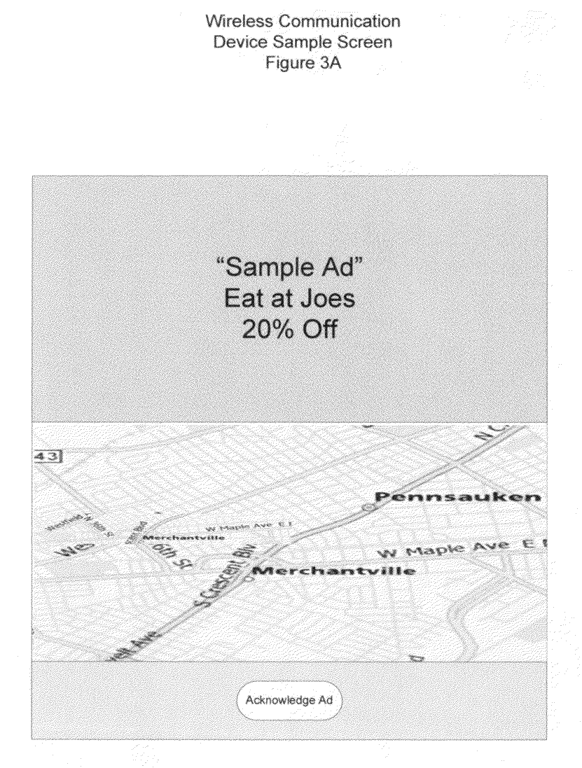

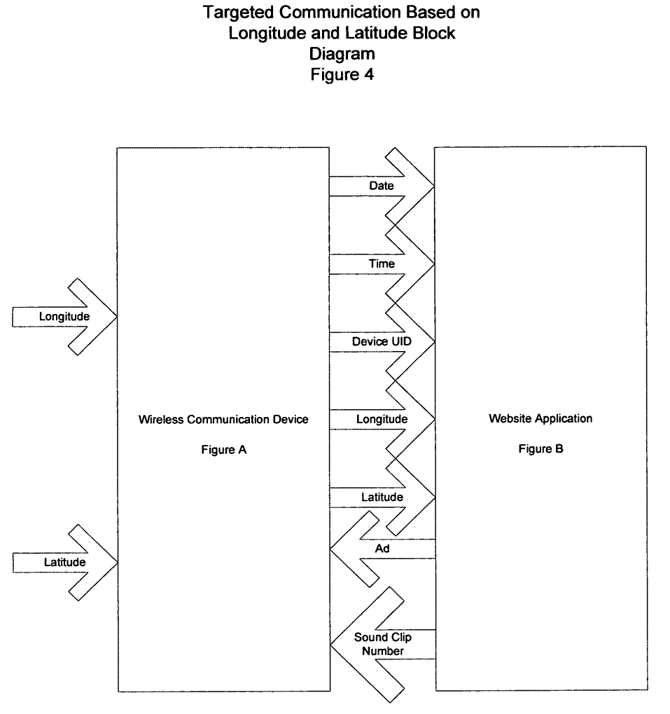

What is being claimed as being new and desired to be protected by Letters Patent of the U.S. as follows:

1. A new and improved system for targeted advertisement communications compromising:
a. Capturing the wireless device current GPS longitude and latitude position.
b. Matching the wireless device GPS longitude and latitude position with that of a selected advertiser within a predefined range of miles, feet, or inches.
c. Sending to the wireless device the assigned advertisement message.
d. Sending to the wireless device a sound assigned to the advertisement message as an indicator to the user that they entered a predefined range of a selected advertiser.
e. Keeping record of previous sent messages to a wireless device so specific targeted advertisements are not repeated while the wireless device is within the predefined range of miles, feet, or inches.

2. The new and improved targeted advertisement communications system as described in claim 1, wherein the ability to send back to the wireless device a map of the location of the targeted advertisement.

3. The new and improved targeted advertisement communications system as described in claim 1, wherein the ability to send back to the wireless device a coupon from the targeted advertiser.
